(19) United States
(12) Patent Application Publication
(10) Pub. No.: US 2001/0039152 A1
(43) Pub. Date: Nov. 8, 2001

(54) Electrical connector

(76) Inventors: Trevor Armistead, Cumbria (GB); Robert Graham Armistead, Cumbria (GB)

Correspondence Address: CHRISTIE, PARKER & HALE, LLP, 350 WEST COLORADO BOULEVARD, SUITE 500, PASADENA, CA, 91105, US

(21) Appl. No.: 09/844,307

(22) Filed: Apr. 27, 2001

(30) Foreign Application Priority Data
Apr. 27, 2000 (GB) 0010282.2

(51) Int. Cl. H01R 13/33

(52) U.S. Cl. 439/841

(57) ABSTRACT

An electrical connector comprising an at least substantially helical winding shaped to provide a first portion, having a diameter suitable to receive and embrace an electrical contact when inserted therein, and a second portion of larger diameter than the first for contacting an electrical terminal when disposed around or adjacent the contact, to thereby form an electrical connection from the contact to the terminal.

### DESCRIPTION

The present invention is concerned with electrical connectors, and particularly (but not exclusively) with compliant electrical connectors for use in planar array filters.

A particularly important application of the present invention relates to filtration of electromagnetic interference (EMI). It is increasingly important to filter EMI from electronic signal interconnections because this spurious interference can otherwise cause serious malfunction of electronic systems.

Conventionally this is achieved in a volumetrically efficient way by incorporating a ceramic planar array inside a multi-way connector. A typical example of this is shown in UK Patent No. 2205201.

Ceramic planar arrays are multi-layer structures whereby metal electrodes are interleaved with ceramic dielectric layers in a monolithic block with lead through holes corresponding to the multi-way contacts of the connector. The electrodes serve as capacitor plates and are designed so that each lead through has a separate capacitance to earth. That is, each lead through is connected to one side of a capacitor the other side of which is connected to the connector outer metal shell which contacts earth through a chassis.

The lead through holes in the planar array are metallised, the metallisation being connected to selected electrodes (ie to one side of the multi-layer capacitor which is to be electrically connected to the lead through contact). The signal is carried by lead through contacts in the form of elongate pins. Clearly there is a requirement for a connection to be formed between the metallisation and the lead through contact itself. This has traditionally been achieved by using a solder connection (eg. as described in GB2214513A) or a spring clip.

An object of the present invention is to provide for the required connection in a robust, reliable and constructionally straightforward manner.

In accordance with a first aspect of the present invention there is an electrical connector comprising an at least substantially helical winding shaped to provide a first portion, having a diameter suitable to receive and embrace an electrical contact inserted therein, and a second portion of larger diameter than the first for contacting an electrical terminal disposed around or adjacent the contact, to thereby form an electrical connection from the contact to the terminal.

The winding may be formed of metal, whose compliance assists in assuring reliable electrical contact.

Benefits which accrue from this simple arrangement include much reduced assembly costs and stress free, compliant, reliable electrical contact, there being no soldering heat nor direct rigid mechanical connection.

The stress produced by temperature changes is also much reduced by having a compliant contact so that expansion/contraction of the metal parts of the connector do not bear upon the brittle ceramic of a planar array.

A planar array utilising connectors according to the present invention can in addition be designed to be repairable, noting that the earth connection to the array is usually sprung from the outer connection of the planar array to the inside of the connector shell.

By making the internal diameter of the first portion smaller than the external diameter of the contact to be inserted therein it can be ensured that pressure and electrical contact between the two is maintained.

The external diameter of the second portion may be selected to be larger than the internal diameter of an electrical terminal formed as a bore into which the second portion is insertable, so that the second portion is radially, compliantly compressed within the bore to maintain pressure and electrical contact between the bore's inner surface and the second portion.

The connector may be formed to function as a compression spring when retained between two opposed, axially facing surfaces in order that the connector may form an electrical connection to at least one of the surfaces.

In certain arrangements the connector may be both radially and axially compliantly deformed.

According to a second aspect of the present invention there is an electrical connection arrangement comprising a connector constructed according to the first aspect of the present invention.

According to a third aspect of the present invention there is an electronic filter comprising a block containing electrodes forming at least one capacitor, at least one lead through hole in the block receiving a lead through contact, and a connector according to the first aspect of the present invention forming an electrical connection from the lead through contact, which is received in the connector, to metallisation of the lead through hole and so to one or more of the electrodes.

Specific embodiments of the present invention will now be described, by way of example only, with reference to the accompanying drawings in which:

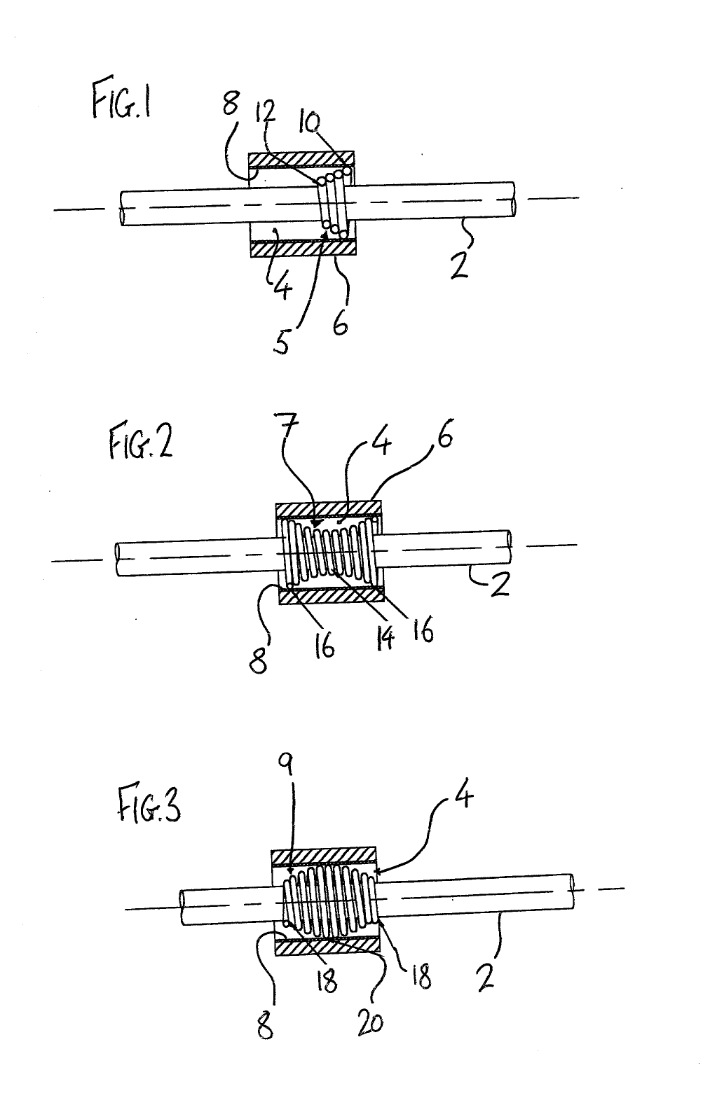

FIGS. 1, 2 and 3 respectively illustrate, in side view and partly in section, connector arrangements comprising first, second and third connectors embodying the present invention;

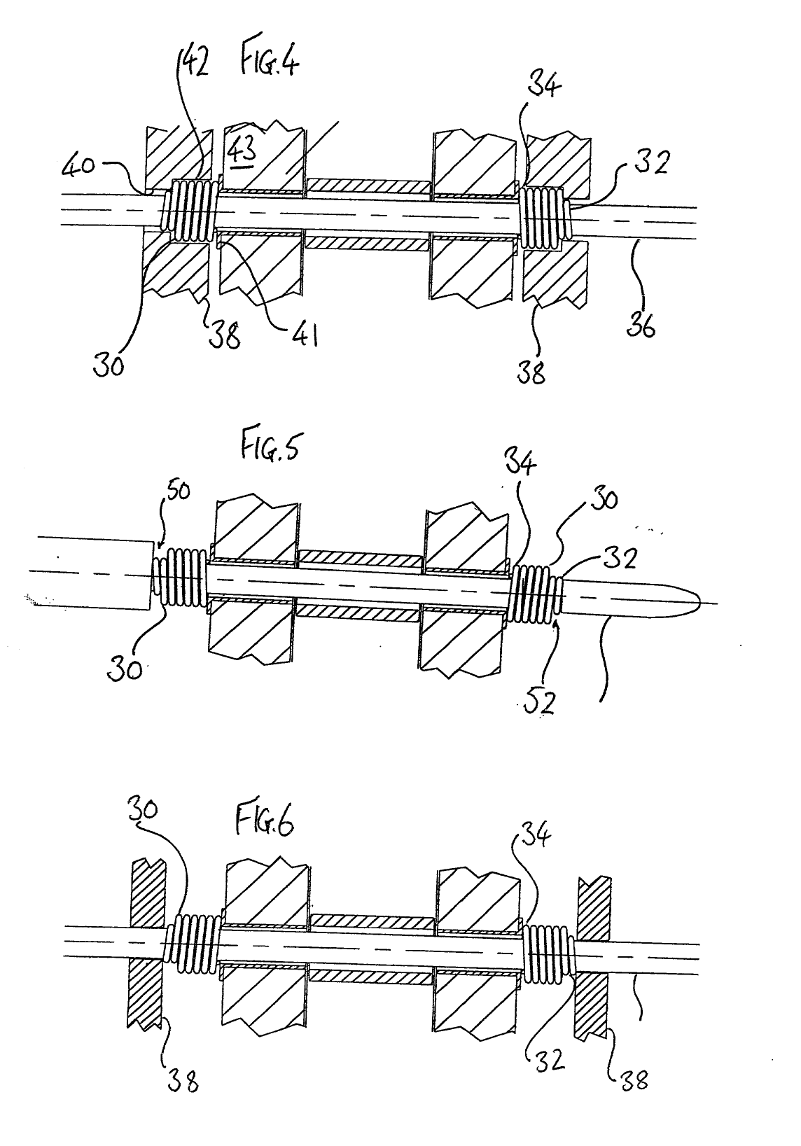

FIGS. 4, 5 and 6 respectively illustrate, again in side view and partly in section, connector arrangements comprising a fourth type of connector embodying the present invention.

Each of the illustrated connectors embodying the present invention is formed as a helical coil of metal wire.

In each of FIGS. 1 to 3 is seen an electrical lead through connection in the form of a pin 2. This is received in a lead through hole 4. In the drawings the lead through hole 4 is formed in a tube 6 but in practice the hole may for example be formed in a planar capacitor array of the type described above. In each of FIGS. 1 to 3 the pin 2 must be connected to an electrical terminal formed by a layer 8 of metallisation formed on the interior of the lead through hole 4. The required connection is formed in each case by a respective connector embodying the present invention.

The connector 5 illustrated in FIG. 1 has a frusto-conical shape formed by several turns of the wire helix, thus providing a larger diameter portion 10 and a smaller diameter portion 12. The diameter of the larger diameter portion 10 is chosen such as to form a reliable contact to the metal layer 8. This diameter is slightly larger than the internal diameter of the metal layer so that upon insertion the portion 10 is slightly deformed ensuring, due to the compliance of the wire from which the connector is formed, that pressure between the metal layer 8 and the larger diameter portion 10 is maintained. The smaller diameter portion 12 is such as to embrace and form a reliable contact to the pin 2, the internal diameter of this portion (prior to insertion of the pin 2) being slightly smaller than the pin's external diameter.

The connector 7 illustrated in FIG. 2 has a waisted shape, a smaller diameter portion 14 for embracing the pin 2 being formed between two larger diameter portions 16 which both contact the metal layer 8.

The connector 9 illustrated in FIG. 3 has a bellied shape, two smaller diameter portions 18 being formed at the connector ends and between them being a larger diameter portion 20.

In each case the diameters chosen and the compliance of the connector 5, 7, 9 ensure that electrical contact between the pin 2 and the metal layer 8 is reliably achieved.

Whereas in each of FIGS. 1 to 3 the connector is radially compressed within its lead through hole 4 to provide the required electrical connection, the embodiments illustrated in FIGS. 4 to 6 each utilise a connector which is axially compressed and which contacts an axially facing terminal surface.

In each case a pair of connectors 30 is provided, both having a smaller diameter end portion 32 followed by a larger diameter portion 34 which serves as a compression spring.

Looking specifically at FIG. 4, a lead through connection is again formed as a pin, labelled 36 in this drawing and passing through a pair of end walls 38, each having a bore 40 receiving the pin 36 and a larger counterbore 42 receiving both the pin and the larger diameter portion 34 of a respective connector 30. The connector 30 is in both cases axially compressed between a shoulder formed at the end of the counterbore and an electrical terminal 41.

The terminal 41 is formed as a metallised ring on a plate 43 facing the end wall 38 and is integral with metallisation within a bore in the plate 43. The contact surface of the terminal 40 faces along the axis of the arrangement and because of the axial compression of the connector, an end of the connector is maintained reliably in contact with this surface. At the connector's other end its smaller diameter portion embraces and so contacts the pin 36.

Other arrangements utilising the same connector 30 are illustrated in FIGS. 5 and 6.

In FIG. 5 axial compression of the connector is achieved by having its smaller diameter portion 32 abut an axially facing shoulder of the pin 36 itself at locations 50 and 52.

FIG. 6 illustrates an arrangement somewhat less axially compact than that of FIG. 4, the connectors 30 not being received in counterbore in the end walls 38.

It should be understood that the connectors 5, 7 and 9 may themselves be used in arrangements in which they are axially compressed, thus exerting both radial and axial forces on the surfaces with which they are in contact.

We claim:

1. An electrical connector comprising an at least substantially helical winding shaped to provide a first portion, having a diameter suitable to receive and embrace an electrical contact when inserted therein, and a second portion of larger diameter than the first for contacting an electrical terminal when disposed around or adjacent the contact, to thereby form an electrical connection from the contact to the terminal.

2. An electrical connector according to claim 1, wherein the winding is formed of metal, whose compliance assists, in use of the connector, in assuring reliable electrical contact.

3. An electrical connector according to claim 1, wherein the second portion is of generally uniform diameter along its axial length.

4. An electrical connector according to claim 1, wherein there are two of said second portions of larger diameter than the first portion, said two second portions being disposed on the two sides respectively of the first portion whereby the connector has a “waisted” shape.

5. An electrical connector according to claim 1, wherein there are two of said first portions disposed on the two sides of the second portion respectively, whereby the connector has a “bellied” shape.

6. An electrical connector arrangement comprising an electrical contact, an electrical terminal and an electrical connector which provides electrical connection between the terminal and the contact, wherein the electrical connector comprises an at least substantially helical winding shaped to provide a first portion, having a diameter suitable to receive and embrace said electrical contact inserted therein, and a second portion of larger diameter than the first and contacting said electrical terminal disposed around or adjacent the contact, to thereby form said electrical connection between the contact and the terminal.

7. An electrical connector arrangement according to claim 6, wherein the external diameter of the second portion of the electrical connector is larger than the internal diameter of the electrical terminal which is formed as a bore into which the second portion is inserted, whereby the second portion is radially, compliantly compressed within the bore of the electrical terminal to maintain pressure and electrical contact between the inner surface of the bore and the second portion.

8. An electrical connector arrangement according to claim 6, wherein the winding is formed of metal, whose compliance assists, in use of the connector, in assuring reliable electrical contact between the contact and the terminal.

9. An electrical connector arrangement according to claim 6, in which the contact comprises an elongate pin.

10. An electrical connector arrangement according to claim 9, wherein the diameter of the turns of said winding of the electrical connector increases progressively along its length from said smaller diameter, first portion which is dimensioned to grip the pin.

11. An electrical connector arrangement according to claim 9, wherein there are two said second portions of larger diameter than the first portion, said two second portions being disposed on the two sides respectively of the first portion whereby the connector has a “waisted” shape, the diameter of the first portion being dimensioned to grip the pin.

12. An electrical connector arrangement according to claim 9, wherein there are two of said first portions disposed on the two sides of the second portion respectively, whereby the connector has a “bellied” shape, the diameters of the first portions being dimensioned to grip the pin.

13. An electrical connector arrangement according to claim 6, wherein the connector is formed to function as a compression spring retained between two opposed, axially facing surface such that the connector forms an electrical connection to at least one of these surfaces.

14. An electrical connector arrangement according to claim 13, wherein one of said surfaces if formed by a wall through which the contact, in the form of an elongate pin, extends.

15. An electrical connector arrangement according to claim 14, wherein the majority of the length of the helical winding lies within a counterbore of the wall, a shoulder at the inner end of said counterbore forming said one of the surfaces.

16. An electrical connector arrangement according to claim 13, wherein the second portion is of generally uniform diameter along its axial length.

17. An electronic filter comprising a block containing electrodes forming at least one capacitor, at least one lead-though hole in the block receiving a lead-though contact, and an electrical connector as claimed in claim 1, forming an electrical connection from the lead-through contact, which is received in the connector, to metallisation of the lead-though hole and so to one or more of the electrodes.
